(19) United States
(12) Patent Application Publication
(10) Pub. No.: US 2011/0229730 A1
(43) Pub. Date: Sep. 22, 2011

(54) OPTICAL FILM FOR PROTECTING POLARIZER, POLARIZER FILM, AND IMAGE DISPLAY DEVICE

(76) Inventors: Takatoshi Yosomiya, Tokyo (JP); Kazuaki Watanabe, Tokyo (JP)

(21) Appl. No.: 13/122,187

(22) PCT Filed: Sep. 29, 2009
(86) PCT No.: PCT/JP2009/066981

§ 371 Date: Jun. 9, 2011

(30) Foreign Application Priority Data
Oct. 2, 2008 (JP) 2008-257797

(51) Int. Cl. C08L 51/06; C08L 23/12; C08J 3/00; B32B 27/00

(52) U.S. Cl. 428/500; 525/70; 525/78; 525/80

(57) ABSTRACT

An optical film for protecting a polarizer is provided that is excellent in mass productivity and is capable being imparted with characteristics by application while maintaining optical characteristics and moisture resistance of polypropylene polymerized with a metallocene catalyst. A polarizer film and an image display device using the same are also provided that have high performance.

The optical film for protecting a polarizer of the present invention contains a mixed resin containing polypropylene that is polymerized with a metallocene catalyst, and graft-modified polypropylene.

### TECHNICAL FIELD

The present invention relates to an optical member used in an image display device, and more particularly relates to an optical film for protecting a polarizer, the optical film being excellent in mass productivity and capable of being imparted with intended characteristics by application. The present invention also relates to a polarizer film containing a polarizer having on at least one surface thereof the optical film, and an image display device containing the polarizer film.

### BACKGROUND ART

A polarizer film is an optical member that has a function of transmitting only light that has a specific oscillation direction but blocking the other light, and is widely used, for example, in an image display device, such as a liquid crystal display device containing a liquid crystal cell, an organic electroluminescence display device and a touch-sensitive panel. The polarizer film that is generally used has a structure containing a polarizer having formed on one surface or both surfaces thereof an optical film for protecting the polarizer. The polarizer among these has a function of transmitting only light that has a specific oscillation direction, and, for example, a uniaxially stretched polyvinyl alcohol (which may be hereinafter referred to as “PVA”) film colored with iodine, a dichroic dye or the like is often used therefor. In recent years, a coating type polarizer has been used, but there is a problem that it is thin and short in strength.

The optical film formed on the polarizer serves functions of supporting the polarizer to impart a practical strength to the entire polarizer film and protecting physically the surface of the polarizer, and is demanded to have a practical physical strength, high transparency, excellent optical homogeneity, such as a low birefringence (in-plane phase retardation), and the like. As the optical film for protecting a polarizer, in general, a cellulose triacetate film, which is a cellulose series film, is often used. However, a cellulose series film is insufficient in humidity resistance, and has problems that the film suffers dimensional change, and the polarizer suffers performance deterioration due to permeated water.

The inventors have found that an optical film for protecting a polarizer, the optical film using polypropylene polymerized with a metallocene catalyst, has both good optical characteristics and moisture resistance (see Patent Document 1).
[Patent Document 1] JP-A-2008-146023

### BRIEF DESCRIPTION OF THE DRAWINGS

FIG. 1 The figure is a diagram showing an example of a structure of a polarizer film of the present invention.

FIG. 2 The figure is a diagram showing an example of a structure of a liquid crystal display device containing a liquid crystal cell of the present invention.

### DESCRIPTION OF THE SYMBOLS

1 optical film for protecting polarizer
2 polarizer
3 adhesive layer
4 polarizer film
5 retardation film (birefringence film)
6 liquid crystal cell

### DISCLOSURE OF THE INVENTION

### Problems to be Solved by the Invention

For subjecting the optical film for protecting a polarizer to practical use, however, it is necessary that the optical film for protecting a polarizer has mass productivity, in addition to the requirements for basic characteristics, i.e., the optical characteristics and the moisture resistance. Furthermore, the optical film for protecting a polarizer is demanded to have such characteristics that correspond to the purpose of the image display device or the polarizer film.

For example, for producing the optical film for protecting a polarizer stably with a large width of at a high speed, it is necessary that the resin used for the optical film for protecting a polarizer has a large tensile strength. It is necessary that the optical film for protecting a polarizer used in a polarizer film for a thin flexible image display device can be formed to have a small thickness and has sufficient flexibility for withstanding flexure. The optical film for protecting a polarizer used in a car-mounted image display device used in cold climates is demanded to have resistance to cold climates (i.e., cold impact strength). These requirements are necessarily satisfied while maintaining the basic characteristics of the optical film for protecting a polarizer.

For satisfying the mass productivity and the characteristics to be achieved by application, techniques of resin modification by addition of an additive or graft copolymerization have been known.

However, in the case where various kinds of polyethylene, such as linear low density polyethylene and high density polyethylene, or a metal crosslinked modified olefin, such as an ionomer resin, is added as an additive to polypropylene polymerized with a metallocene catalyst, the resins are poor in compatibility to each other and thus are separated upon heat molding, which considerably impairs the birefringence and the transparency. When the amount of the additive added is decreased to avoid the problems, the sufficient characteristics cannot be obtained. Furthermore, for example, a dibenzilidene sorbitol additive or the like provides only limited modification effects.

In the case where the resin modification of polypropylene is to be achieved by graft copolymerization, for example, with an acrylic compound, it has been known that it is difficult to form a thin film homogeneous in resin components having good appearance, by molding the film only with the graft-modified polypropylene. It is expected that this is because there is a considerably difference in thermal characteristics between the graft-modification acrylic component and the polypropylene component in the graft-modified polypropylene, and thus the suitable resin melting temperatures of the resins are different from each other.

The present invention is developed under the circumstances, and an object of the present invention is to provide an optical film for protecting a polarizer that is excellent in mass productivity and is capable being imparted with characteristics by application while maintaining optical characteristics and moisture resistance of polypropylene polymerized with a metallocene catalyst. Another object thereof is to provide a polarizer film and an image display device that have high performance using the same.

### Means for Solving the Problems

As a result of earnest investigations made by the inventors for achieving the objects, it has been found that the problems are resolved by using a mixed resin of polypropylene polymerized with a metallocene catalyst and graft-modified polypropylene. The present invention has been accomplished based on the findings.

A first invention relates to an optical film for protecting a polarizer, containing a mixed resin containing polypropylene that is polymerized with a metallocene catalyst, and graft-modified polypropylene.

A second invention relates to the optical film for protecting a polarizer according to the first invention, wherein the graft-modified polypropylene is modified polypropylene graft-copolymerized with an acrylic compound.

A third invention relates to the optical film for protecting a polarizer according to the first invention, wherein the graft-modified polypropylene is modified polypropylene graft-copolymerized with a vinyl compound.

A fourth invention relates to the optical film for protecting a polarizer according to the first invention, wherein the graft-modified polypropylene is modified polypropylene graft-copolymerized with styrene or a derivative thereof.

A fifth invention relates to the optical film for protecting a polarizer according to the second invention, wherein the acrylic compound is acrylic acid, methacrylic acid, or a derivative thereof.

A sixth invention relates to the optical film for protecting a polarizer according to the fifth invention, wherein a mass proportion of a constitutional component derived from acrylic acid, methacrylic acid, or a derivative thereof in the mixed resin is from 5 to 30% by mass.

A seventh invention relates to the optical film for protecting a polarizer according to the fifth invention, wherein the optical film for protecting a polarizer has tensile strengths in a machine direction and a transversal direction each of 30 MPa or more.

An eighth invention relates to a polarizer film containing a polarizer having on at least one surface thereof the optical film for protecting a polarizer according to one of the first to seventh inventions.

A ninth invention relates to an image display device containing the polarizer film according to the eighth invention.

A tenth invention relates to a method for producing an optical film for protecting a polarizer, containing the following steps (1) to (4):

step (1): a step of polymerizing polypropylene with a metallocene catalyst;

step (2): a step of graft-copolymerizing a branch polymer to polypropylene as a stem polymer, thereby providing graft-modified polypropylene;

step (3): a step of mixing and melting under heat the polypropylene polymerized with a metallocene catalyst and the graft-modified polypropylene, thereby providing a mixed resin; and

step (4); a step of molding the mixed resin.

### Advantages of the Invention

According to the present invention, a practical optical film for protecting a polarizer can be provided that is excellent in mass productivity and is capable being imparted with characteristics by application while maintaining the optical characteristics and the moisture resistance of the polypropylene polymerized with a metallocene catalyst. Furthermore, a polarizer film and an image display device that have high performance and are imparted with characteristics by application can be provided.

In the present invention, it is expected that the factors maintaining the excellent optical characteristics and moisture resistance of the polypropylene polymerized with a metallocene catalyst and the factors causing no separation or failure upon molding under heat are that both the polypropylene polymerized with a metallocene catalyst and the graft-modified polypropylene have a polypropylene component, and thus the resins have compatibility with each other, thereby providing a homogeneous mixed resin. It is also expected that the graft-modification component in the graft-modified polypropylene is dispersed in the matrix formed of the polypropylene component of the graft-modified polypropylene and the polypropylene polymerized with a metallocene catalyst, and thus the homogeneity can be maintained upon molding under heat.

In the case where the modified polypropylene graft-copolymerized with an acrylic compound is used as the graft-modified polypropylene, the resin used in the optical film for protecting a polarizer can be enhanced in tensile strength. According to the constitution, for example, the optical film for protecting a polarizer can be produced stably with a large width of at a high speed. Furthermore, the film strength is enhanced, and thus the polarizer protecting capability can be enhanced. The improvement in tensile strength is important since polypropylene generally has a small tensile strength.

In the case where the modified polypropylene graft-copolymerized with a vinyl compound is used as the graft-modified polypropylene, the resin used in the optical film for protecting a polarizer can be imparted with flexibility. According to the constitution, for example, the optical film for protecting a polarizer can be molded into a thin film, and the resulting optical film for protecting a polarizer withstands flexure and thus can be favorably used as a polarizer film of a thin flexible image display device.

In the case where the modified polypropylene graft-copolymerized with styrene or a derivative thereof is used as the graft-modified polypropylene, the resin used in the optical film for protecting a polarizer can be imparted with cold impact strength. According to the constitution, for example, in the case where the optical film for protecting a polarizer is used as a polarizer film in a car-mounted image display device, the optical film for protecting a polarizer withstands the use in cold climates.

In the case where the acrylic compound is acrylic acid, methacrylic acid, or a derivative thereof, the influence thereof on the transparency and the birefringence (in-plane phase retardation) can be decreased.

In the case where the mass proportion of the constitutional component derived from acrylic acid, methacrylic acid, or a derivative thereof in the mixed resin is from 5 to 30% by mass, wrinkles at the edges of the film, which cause problems on molding with a large width of at a high speed, can be prevented from occurring. The optical film for protecting a polarizer obtained with the aforementioned range is particularly favorable in transparency and birefringence (in-plane phase retardation).

In the case where the optical film for protecting a polarizer has tensile strengths in the machine direction and the transversal direction each of 30 MPa or more, a phenomenon where the film is suddenly broken can be prevented from occurring, in addition to the prevention of occurrence of wrinkles at the edges of the film.

### Best Mode for Carrying Out the Invention

### Optical Film for Protecting Polarizer

The optical film for protecting a polarizer of the present invention contains a mixed resin containing polypropylene polymerized with a metallocene catalyst, and graft-modified polypropylene.

The optical film for protecting a polarizer of the present invention may be produced in such a manner that the polypropylene polymerized with a metallocene catalyst and the graft-modified polypropylene are mixed and melted under heat, and then molded, for example, by various molding methods, such as a non-stretching T-die extrusion molding method.

In the present invention, the graft-modified polypropylene means polypropylene that is imparted with characteristics by graft copolymerization reaction. On the other hand, the unmodified polypropylene means polypropylene that is not imparted with, characteristics by graft copolymerization reaction, and examples thereof include a polypropylene homopolymer, and a random copolymer, an alternating copolymer and a block copolymer of propylene and an α-olefin.

The optical film for protecting a polarizer and the production method thereof will be described in detail below.

Polypropylene Polymerized with Metallocene Catalyst

The polypropylene polymerized with a metallocene catalyst is a propylene polymer that is synthesized by polymerization reaction by using a metallocene catalyst described later. The polypropylene polymerized with a metallocene catalyst generally has such characteristics that it is homogeneous in molecular weight and crystallinity and contains a small amount of a low molecular weight and low crystallinity component, as compared to general-purpose polypropylene polymerized with a Ziegler catalyst, and therefore, an optical film for protecting a polarizer using the polypropylene polymerized with a metallocene catalyst has high transparency and a low birefringence as compared to an optical film for protecting a polarizer using only the polypropylene polymerized with a Ziegler catalyst. In the present invention, accordingly, the polypropylene polymerized with a metallocene catalyst is used as one of the essential components of the mixed resin constituting the optical film for protecting a polarizer of the present invention.

The polypropylene polymerized with a metallocene catalyst is preferably a random copolymer of propylene and an α-olefin. Examples of the α-olefin includes ethylene and a 1-olefin having from 4 to 18 carbon atoms, and more specifically ethylene, 1-butene, 1-pentene, 1-hexene, 1-octene, 1-heptene, 4-methyl-pentene-1,4-methyl-hexene-1 and 4,4-dimethylpentene-1. The proportion of the propylene unit in the copolymer is preferably 80% by mol or more, and the proportion of the comonomer is preferably 20% by mol or less. The comonomer is not limited to one kind of the aforementioned α-olefin, but two or more kinds thereof may be used to provide a multi-component copolymer, such as a terpolymer, as the copolymer.

### Metallocene Catalyst

As the metallocene catalyst, known ones may be appropriately used. Examples of the catalyst generally used include a Group 4 to 6 transition metal compound, such as Zr, Ti and Hf, and particularly a Group 4 transition metal compound, and an organic transition metal compound having a cyclopentadienyl group or a group derived from a cyclopentadienyl derivative.

Examples of the group derived from a cyclopentadienyl derivative include an alkyl-substituted group, such as pentamethylcyclopentadienyl, and a group constituting a saturated or unsaturated cyclic substituent by bonding two or more substituents, and representative examples thereof include an indenyl group, a fluorenyl group, an azulenyl group, and partially-hydrogenated groups thereof. Preferred examples thereof also include groups containing plural cyclopentadienyl groups bonded through an alkylene group, a silylene group, a germylene group or the like.

### Co-Catalyst

Examples of a co-catalyst that can be used include at least one compound selected from a group consisting of an aluminiumoxy compound, anionic compound capable of reacting with a metallocene compound to convert the metallocene compound component into a cation, a Lewis acid, a solid acid and a layered silicate salt. An organoaluminum compound may be added along with those compounds depending on necessity.

The layered silicate salt is a silicate salt compound having a crystal structure, in which the constitutive layers are accumulated in parallel to each other with a weak bonding force, such as an ionic bond. In the present invention, the layered silicate salt is preferably ion-exchangeable. The ion-exchangeable property referred herein means that the interlayer cation of the layered silicate salt is exchangeable. Most layered silicate salts as natural products are produced mainly as a main ingredient of clay minerals, and the layered silicate salt used herein is not limited to the naturally produced ones but may be synthetic ones.

Specific examples of the layered silicate salt include known layered silicate salts without particular limitation, and for example, include a kaolin mineral, such as dickite, nacrite, kaolinite, anauxite, metahalloysite and halloysite; a surpentine mineral, such as chrysotile, lizardite and antigorite; a smectite mineral, such as montmorillonite, zaukonite, viderite, nontronite, saponite, tainiolite, hectorite and stevensite; a vermiculite mineral, such as vermiculite; a mica mineral, such as mica, illite, sericite and glauconite; attapulgite; sepiolite; palygorskite; bentonite; pyrophyllite; talc; and a chlorite mineral. These may form a mixed layer.

Among these, a smectite mineral, such as montmorillonite, zaukonite, viderite, nontronite, saponite, hectorite, stevensite, bentonite and tainiolite; a vermiculite mineral; and a mica mineral are preferred.

The layered silicates may be chemically treated. The chemical treatment employed herein may be any of a surface treatment that removes impurities attached to the surface and a treatment that makes influences on the crystalline structure and the chemical composition of the layered silicate. Specific examples of the treatment include an acid treatment, an alkali treatment, a salt treatment and an organic substance treatment. The treatments remove impurities from the surface, exchange the interlayer cation, or elute the cation, such as Al, Fe and Mg, in the crystalline structure, thereby forming an ionic complex, a molecular complex, an organic derivative or the like, which changes the surface area, the interlayer distance, the solid acidity or the like. The treatments may be performed solely, or two or more of the treatments may be combined.

Polymerization Method of Polypropylene with Metallocene Catalyst

Examples of the method of synthesizing polypropylene with the metallocene catalyst (polymerization method) include a slurry method using an inert solvent, a gas phase method using substantially no solvent, a solution method, and a bulk polymerization method using the polymerizable monomer as a solvent, in the presence of the catalyst.

The polypropylene thus polymerized with, the metallocene catalyst preferably has a melting point (Tm) of 130° C. or more.

Discrimination Method of Polypropylene with Metallocene Catalyst

The polypropylene synthesized with a metallocene catalyst contains therein a residue of a Group 4 to 6 transition metal compound derived from the metallocene catalyst. On the other hand, polypropylene synthesized with a Ziegler catalyst contains therein a residue of a Group 1 to 3 metal compound or an organic metal compound derived from the Ziegler catalyst. Therefore, polypropylene synthesized with a metallocene catalyst and polypropylene synthesized with a Ziegler catalyst can be clearly discriminated from each other by analyzing the residual metal compound derived from the catalyst used in the polypropylene.

Examples of the analysis method include, while depending on the residual amount of the metal compound in the polypropylene, analysis by a fluorescent x-ray analyzer, and qualitative analysis with an electron beam microanalyzer (EPMA) after increasing the residue concentration by a pretreatment, such as incineration.

### Graft-Modified Polypropylene

The graft-modified polypropylene is a polypropylene polymer obtained by graft copolymerization of various kinds of branch polymers with polypropylene as the stem polymer. Compatibility with the polypropylene polymerized with a metallocene catalyst can be obtained owing to the presence of the polypropylene component as the stem polymer. The graft copolymerization of the branch polymer achieves resin modification corresponding to the processability and the application of the optical film for protecting a polarizer. In the present invention, accordingly, the graft-modified polypropylene is used as one of the essential components of the mixed resin constituting the optical film for protecting a polarizer of the present invention.

Examples of the polypropylene used as the stem polymer include a propylene homopolymer, and a block copolymer, a random copolymer or copolymer rubber of propylene and one kind or two or more kinds of an α-olefin. Examples of the α-olefin include ethylene and an olefin having from 4 to 18 carbon atoms, and more specifically ethylene, 1-butene, 1-pentene, 1-hexene, 1-octene, 1-heptene, 4-methyl-pentene-1, 4-methyl-hexene-1 and 4,4-dimethylpentene-1. The proportion of the propylene unit in the copolymer is preferably 80% by mol or more, and the proportion of the comonomer is preferably 20% by mol or less. The comonomer is not limited to one kind of the aforementioned α-olefin, but two or more kinds thereof may be used to provide a multi-component copolymer, such as a terpolymer, as the copolymer. In the polymerization reaction for synthesizing the stem polymer, any of a Ziegler catalyst and a metallocene catalyst may be used.

The polypropylene as the stem polymer is preferably a propylene homopolymer or a random copolymer of propylene and ethylene since these polymers have good compatibility with the polypropylene polymerized with a metallocene catalyst.

The various kinds of branch polymers may be appropriately selected depending on the demanded characteristics as far as they are ones capable of being graft-polymerized with the polypropylene as the stem polymer. Preferred examples thereof include an acrylic compound, a vinyl compound, an olefin, a diene, styrene and a derivative thereof.

The acrylic compound is preferably used for enhancing the tensile strength of the optical film for protecting a polarizer. Specific examples of the acrylic compound include acrylic acid, methacrylic acid, or a derivative thereof, α-cyanoacrylic acid and a derivative thereof, and acrylonitrile. Preferred specific examples of the derivative of acrylic acid or methacrylic acid include an alkyl ester (such as a methyl ester, an ethyl ester, a 2-hydroxyethyl ester and a diethylaminoester), a glycidyl ester, a salt (such as an alkali metal salt, e.g., a sodium salt), a halide (such as a chloride), and an amide, of acrylic acid or methacrylic acid.

As the acrylic compound, acrylic acid, methacrylic acid, or a derivative thereof is preferred since acrylic acid, methacrylic acid, or a derivative thereof imparts high transparency and tensile strength and facilitates production of the graft copolymer with the propylene as the stern polymer.

The mass proportion of the constitutional component derived from acrylic acid, methacrylic acid, or a derivative thereof in the mixed resin is preferably from 5 to 30% by mass In the case where the proportion is in the range, wrinkles at the edges of the film, which are liable to occur upon molding with a large width of at a high speed, can be prevented from occurring. Furthermore, the optical film for protecting a polarizer obtained is particularly favorable in transparency and birefringence (in-plane phase retardation).

The vinyl compound is preferably used for enhancing the flexibility of the optical film for protecting a polarizer. Preferred specific examples of the vinyl compound include a vinyl compound, such as vinyl acetate, vinyl chloride and a vinyl ether (for example, methyl vinyl ether), vinylidene chloride, tetrafluoroethylene and a vinylpyridine compound.

The styrene or a derivative thereof is preferably used for enhancing the cold impact strength of the optical film for protecting a polarizer. Preferred specific examples of the styrene or a derivative thereof include styrene and methoxystyrene. An olefin (such as ethylene, butylene and isobutylene), a diene (such as butadiene) and the like are effective for enhancing the cold impact strength and may also be preferably used.

The aforementioned compounds solely or a combination of two or more kinds thereof may be used as the branch polymer. The number average molecular weight of the branch polymer is preferably in a range of from 5,000 to 1,000,000, and the mass proportion of the graft component in the graft-modified polypropylene is preferably from 30 to 60% by mass.

### Other Components

In the present invention, various additives and additional resins may be added as arbitrary components to the mixed resin constituting the optical film for protecting a polarizer.

For example, a dibenzylidene sorbitol additive may be preferably used since it enhances the tensile strength and the transparency while suppressing the influence on the phase retardation. Preferred examples of the dibenzylidene sorbitol additive include a di-substituted dibenzylidene sorbitol, such as 1,3-2,4-dibenzylidene sorbitol and 1,3-2,4-di-p-methylbenzylidene sorbitol, and a mixture of a di-substituted benzylidene sorbitol and a diglycerin monofatty acid ester.

In the dibenzylidene sorbitol additives, a diglycerin monofatty acid ester-added dibenzylidene sorbitol nucleating agent is preferred since it exhibits less bleeding out and is stable. Preferred examples of the diglycerin monofatty acid ester include diglycerin monolaurate ester, diglycerin monomyristate ester and diglycerin monostearate ester, which may be used solely or as a mixture thereof.

The content of the additive is preferably in a range of from 0.03 to 0.5 part by mass per 100 parts by mass of the mixed resin. In the case where the content is 0.03 part by mass or more, the transparency and the strength can be sufficiently enhanced. In the case where the content exceeds 0.5 part by mass, it is not advantageous in view of the cost since no further enhancement of the transparency and the strength may be obtained.

In the case where a di-substituted benzylidene sorbitol having a diglycerin monofatty acid ester added thereto is used, the amount of the di-substituted benzylidene sorbitol added is preferably from 0.01 to 0.3% by mass, and the amount of the diglycerin monofatty acid ester added is preferably from 0.01 to 0.2 part by mass, per 100 parts by mass of the mixed resin.

Various kinds of olefin resins other than the polypropylene polymerized with a metallocene catalyst and the graft-modified polypropylene may be added as an additional resin depending on the desired properties of the resulting film in such a range that does not impair the demanded birefringence and transparency.

Furthermore, for example, a weather resistance improving agent, an abrasion resistance improving agent, a polymerization inhibitor, a crosslinking agent, an infrared ray absorbent, an antistatic agent, an adhesion improving agent, a leveling agent, a thixotropy imparting agent, a coupling agent, a plasticizer, a defoaming agent, a filler, a solvent and the like may be added depending on necessity in such a range that does not impair the demanded birefringence and transparency.

An ultraviolet ray absorbent and a light stabilizer may be used as the weather resistance improving agent.

The ultraviolet ray absorbent may be an inorganic series or an organic series, and preferred examples of the inorganic ultraviolet ray absorbent include titanium dioxide, cerium oxide and zinc oxide, having an average particle diameter of approximately from 5 to 120 nm. Examples of the organic ultraviolet ray absorbent include a benzotriazole ultraviolet ray absorbent, specifically 2-(2-hydroxy-5-methylphenyl)benzotriazole, 2-(2-hydroxy-3,5-di-tert-amylphenyl)benzotriazole and polyethylene glycol 3-(3-(benzotriazol-2-yl)-5-tert-butyl-4-hydroxyphenyl)-propionate.

Examples of the light stabilizer include a hindered amine light stabilizer, specifically bis(1,2,2,6,6-pentamethyl-4-piperidyl) 2-(3,5-di-tert-butyl-4-hydroxybenzyl)-2′-n-butylmalonate, bis(1,2,2,6,6-pentamethyl-4-piperidyl) sebacate and tetrakis(2,2,6,6-tetramethyl-4-piperidyl) 1,2,3,4-butanetetracarboxylate.

As the ultraviolet ray absorbent and the light stabilizer, a reactive ultraviolet ray absorbent or light stabilizer having a polymerizable group, such as a (meth)acryloyl group, in the molecule may be used.

Examples of the abrasion resistance improving agent include an inorganic substance, such as spherical particles of α-alumina, silica, kaolinite, iron oxide, diamond and silicon carbide. The shape of the particles is not particularly limited, and examples thereof include a sphere, an ellipsoid, a polyhedron and a flake, and preferably a spherical shape. Examples of the abrasion resistance improving agent also include an organic substance, such as synthetic resin beads, e.g., a crosslinked acrylic resin and a polycarbonate resin. The particle diameter thereof may be generally approximately from 30 to 200% of the thickness of the optical film for protecting a polarizer. Among these, spherical α-alumina is especially preferred since it has high hardness exhibiting large effect on enhancement of the abrasion resistance, and spherical particles thereof are relatively easily provided.

Examples of the polymerization inhibitor include hydroquinone, p-benzoquinone, hydroquinone monomethyl ether, pyrogallol and t-butylcatechol, and examples of the crosslinking agent include a polyisocyanate compound, an epoxy compound, a metal chelate compound, an aziridine compound and an oxazoline compound.

Examples of the filler include barium sulfate, talc, clay, calcium carbonate and aluminum hydroxide.

Examples of the infrared ray absorbent include a dithiol metallic complex, a phthalocyanine compound and a diimmonium compound.

### Optical Film for Protecting Polarizer

The optical film for protecting a polarizer preferably has a thickness in a range of from 10 to 200 μm, and more preferably from 30 to 150 μm. When the thickness is 10 μm or more, the protection strength of the optical film for protecting a polarizer is sufficiently ensured, and when the thickness is 200 μm or less, the film has sufficient flexibility and is easily handled owing to the light weight thereof, and it is advantageous in cost.

The optical film for protecting a polarizer may be controlled to have a desired bending elastic modulus, for example, by using a method of selecting the characteristics (such as the crystallinity and the average molecular weight) inherent to the polypropylene, a method of adding a filler selected from inorganic and organic fillers to the resin, a method of adding a crosslinking agent, a method of mixing two or more kinds of resins having elastic moduli different from each other, or a method of selecting a plasticizer component of a curing resin, or by using a combination of plural methods of these methods.

The optical film for protecting a polarizer preferably has a bending elastic modulus of 700 MPa or more. When the bending elastic modulus is in the range, sufficient stiffness is obtained upon handling the film to facilitate post-processing, and sufficient abrasion resistance for functioning as a protection sheet for a polarizer film is obtained. The bending elastic modulus of the optical film for protecting a polarizer is more preferably 900 MPa or more. When the bending elastic modulus is 900 MPa or more, the in-plane phase retardation can be stabilized upon producing the film by T-die extrusion molding.

In the present invention, the bending elastic modulus is measured according to JIS K7171.

The optical film for protecting a polarizer preferably has a tensile strength of 20 MPa or more. When the tensile strength is 20 MPa or more, the optical film for protecting a polarizer is not oriented upon molding the optical film for protecting a polarizer by adhering the optical film to a polarizer through an adhesive layer by a roll-to-roll method, whereby the optical film does not suffer phase retardation, and the capability of the polarizer film is maintained.

In the case where the modified polypropylene graft-copolymerized with acrylic acid, methacrylic acid, or a derivative thereof is mixed, the tensile strength in the machine direction of the optical film for protecting a polarizer is preferably 30 MPa or more since the film can be prevented from suffering breakage and wrinkles. The tensile strength, in the transversal direction of the optical film for protecting a polarizer is preferably 30 MPa or more. In the case where the modified polypropylene graft-copolymerized with acrylic acid, methacrylic acid, or a derivative thereof, the film may suffer accidental breakage, which can be prevented from occurring when the tensile strength in the transversal direction is in the range. The tensile strengths in the machine and transversal directions are both particularly preferably 30 MPa or more since high stability is obtained upon molding.

In the present invention, the tensile strength is measured according to ASTM D638 (Type 4). The machine direction herein means the film flowing direction upon molding the mixed resin into a film form, and the transversal direction herein means the direction perpendicular to the machine direction in the film plane.

The optical film for protecting a polarizer may be subjected to an adhesion facilitating treatment for enhancing adhesion on the surface in contact with a polarizer. Examples of the adhesion facilitating treatment include a surface treatment, such as a corona treatment, a plasma treatment, a low pressure UV treatment and a saponification treatment, and a method of forming an anchor layer, which may be used in combination. Among these, a corona treatment, a method of forming an anchor layer, and a method using these methods in combination are preferred.

In the case where an adhesive layer is formed, for enhancing adhesion of the optical film for protecting a polarizer to a polarizer, an adhesive may be coated on one side or both sides of the optical film for protecting a polarizer and the polarizer.

After adhering the optical film for protecting a polarizer to the polarizer through the surface having been subjected to the adhesion facilitating treatment or the surface having an adhesive layer coated thereon, the assembly is dried to form an adhesive layer formed of a coated and dried layer. They may be adhered after forming the adhesive layer. The adhesion of the polarizer and the optical film for protecting a polarizer may be performed with a roll laminator or the like. The heat drying temperature and the drying time may be appropriately determined depending on the species of the adhesive.

The thickness of the adhesive layer is preferably from 0.01 to 10 μm, and more preferably from 0.03 to 5 μm, since too large the thickness is not preferred from the standpoint of adhesion property of the optical film for protecting a polarizer.

On the surface of the optical film for protecting a polarizer, a functional layer may be laminated to impart various functions thereto, for example, a hard-coating function, which achieves abrasion resistance by high hardness, an anti-fogging coating function, an antifouling coating function, an antiglare coating function, an antireflection coating function, an ultraviolet ray shield coating function and an infrared ray shield coating function.

### Production Method of Optical Film for Protecting Polarizer

The optical film for protecting a polarizer is preferably produced according to the production method containing: (1) a step of polymerizing polypropylene with the metallocene catalyst; (2) a step of graft-copolymerizing a branch polymer to polypropylene as a stem polymer, thereby providing graft-modified polypropylene; (3) a step of mixing and melting under heat the polypropylene polymerized with a metallocene catalyst and the graft-modified polypropylene, thereby providing a mixed resin; and (4) a step of molding the mixed resin.

In the step (3), more specifically, the polypropylene polymerized with the metallocene catalyst obtained in the step (1) and the graft-modified polypropylene obtained in the step (2) are mixed and melted under heat along with various kinds of additives and additional resins depending on necessity, thereby providing a mixed resin.

The resulting mixed resin is formed into the optical film for protecting a polarizer of the invention through the molding step (4). The molding step may be performed by various molding methods, such as an extrusion coating method, a casting method, a T-die extrusion molding method, an inflation molding method and an injection molding method. In the present invention, a T-die extrusion molding method applying no stretching is preferred since the optical film for protecting a polarizer to be produced on a polarizer is demanded not to be oriented.

### Polarizer Film

The polarizer film of the present invention contains a polarizer having adhered on one surface or both surfaces thereof the optical film for protecting a polarizer of the present invention. The polarizer film may be produced by forming the optical film for protecting a polarizer directly on the polarizer, or may be produced by producing the optical film for protecting a polarizer in advance and then adhering the same to the polarizer through an adhesive layer.

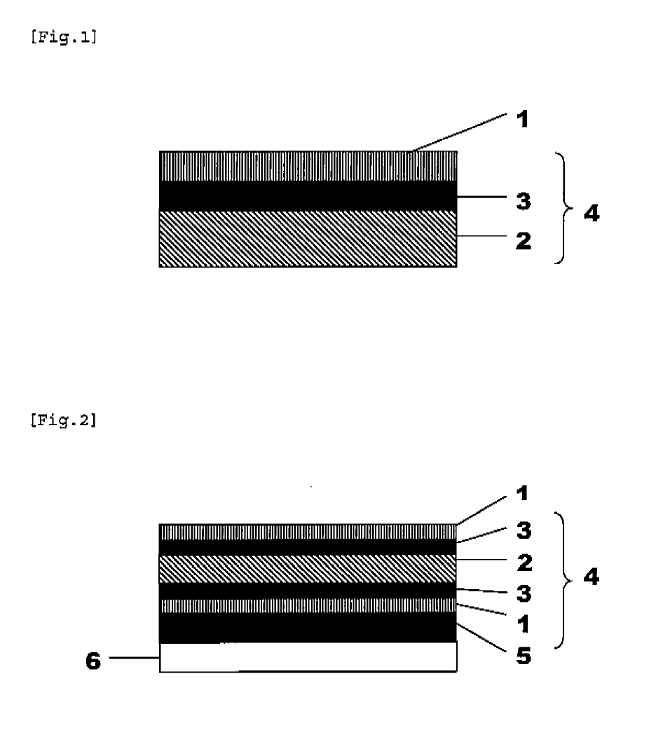

FIG. 1 shows an example of a polarizer film according to the present invention. In FIG. 1, numeral 2 denotes a polarizer, and on one surface thereof an optical film for protecting a polarizer 1 is formed through an adhesive layer 3, thereby constituting totally a polarizer film 4.

The polarizer film of the present invention is a high performance polarizer film having characteristics by application imparted by the optical film for protecting a polarizer.

### Polarizer

The polarizer used in the polarizer film may be any polarizer having a function of transmitting only light that has a specific oscillation direction, and examples thereof include a PVA polarizer formed by stretching a PVA film or the like followed by dyeing it with iodine, a dichroic dye or the like; a polyene polarizer, such as a dehydrated product of PVA or a dehydrochlorinated product of polyvinyl chloride; a reflection type polarizer using a cholesteric liquid crystal; and a thin crystal film polarizer. Among those, a PVA polarizer is preferably used.

Examples of the PVA polarizer include ones produced in such a manner that a dichroic substance, such as iodine and a dichroic dye, is adsorbed to a hydrophilic polymer film, such as a PVA film, a partially formalized polyvinyl alcohol film and a partially saponified ethylene-vinyl acetate copolymer film, which is then uniaxially stretched. Among these, a polarizer containing a PVA film and a dichroic substance, such as iodine, is preferably used. The thickness of the polarizer is not particularly limited and may be generally approximately from 1 to 100 μm.

The PVA resin favorably used as a resin constituting the polarizer may be produced through saponification of a polyvinyl acetate resin. Examples of the polyvinyl acetate resin include polyvinyl acetate, which is a homopolymer of vinyl acetate, and also include a copolymer of vinyl acetate with another monomer copolymerizable therewith. Examples of the another monomer copolymerized with vinyl acetate include an unsaturated carboxylic acid, an olefin, a vinyl ether and an unsaturated sulfonic acid.

The degree of saponification of the PVA resin may be generally from 85 to 100 mol %, and preferably from 98 to 100 mol %. The PVA resin may be further modified, and for example, polyvinyl formal and polyvinyl acetal, which are modified with an aldehyde, may be used. The degree of polymerization of the PVA resin is generally from 1,000 to 10,000, and preferably from 1,500 to 10,000.

### Production Method of Polarizer Film

The polarizer film may be produced through (I) a step of uniaxially stretching the PVA resin film, (II) a step of dyeing the PVA resin film with a dichroic colorant, whereby the dichroic colorant is adsorbed thereto, (III) a step of treating the PVA resin film having the dichroic colorant absorbed thereto with an aqueous boric acid solution, (IV) a step of rinsing after treatment with the aqueous boric acid solution, and (V) a step of adhering the optical film for protecting a polarizer to the uniaxially stretched PVA resin film having the dichroic colorant adsorbed thereon and having been oriented through the previous steps.

### Step (I)

The uniaxial stretching may be performed before dyeing with the dichroic colorant, or simultaneously with dying with the dichroic colorant, or may be performed after dyeing with the dichroic colorant. In case where the uniaxial stretching is performed after dyeing with the dichroic colorant, the uniaxial stretching may be performed before the treatment with boric acid, or during the treatment with boric acid. The uniaxial stretching may be performed in the plural steps among these steps. For performing the uniaxial stretching, the film may be uniaxially stretched between rolls having peripheral speeds different from each other, or may be uniaxially stretched with a hot roll. It may be dry stretching performed in the air, or may be wet stretching of stretching the film in a swollen state with a solvent. The stretching ratio may be generally approximately from 4 to 8 times.

### Step (II)

For dyeing the PVA resin film with the dichroic colorant, for example, the PVA resin film may be immersed in an aqueous solution of the dichroic colorant. Examples of the dichroic colorant used include iodine and a dichroic dye.

In the case where iodine is used as the dichroic colorant, such a method may be generally employed that the PVA resin film is dyed by immersing in an aqueous solution containing iodine and potassium iodide. The content of iodine in the aqueous solution is generally approximately from 0.01 to 0.5 parts by mass per 100 parts by mass of water, and the content of potassium iodide is generally approximately from 0.5 to 10 parts by mass per 100 parts by mass of water. The temperature of the aqueous solution is generally approximately from 20 to 40° C., and the immersing time in the aqueous solution is generally approximately from 30 to 300 seconds.

In case where a dichroic dye is used as the dichroic colorant, on the other hand, such a method may be generally employed that the PVA resin film is dyed by immersing in an aqueous solution containing a water-soluble dichroic dye. The content of the dichroic dye in the aqueous solution is generally approximately from 1×10⁻³ to 1×10⁻² parts by mass per 100 parts by mass of water. The aqueous solution may contain an inorganic salt, such as sodium sulfate. The temperature of the aqueous solution is generally approximately from 20 to 80° C., and the immersing time in the aqueous solution is generally approximately from 30 to 300 seconds.

### Step (III)

The treatment with boric acid after dyeing with the dichroic colorant may be performed by immersing the dyed PVA resin film in an aqueous boric acid solution. The content of boric acid in the aqueous boric acid solution is generally approximately from 2 to 15 parts by mass, and preferably from 5 to 12 parts by mass, per 100 parts by mass of water.

In case where iodine is used as the dichroic colorant, the aqueous boric acid solution preferably contains potassium iodide. The content of potassium iodide in the aqueous boric acid solution is generally approximately from 2 to 20 parts by mass, and preferably from 5 to 15 parts by mass, per 100 parts by mass of water. The immersing time in the aqueous boric acid solution is generally approximately from 100 to 1,200 seconds, preferably approximately from 150 to 600 seconds, and more preferably approximately from 200 to 400 seconds. The temperature of the aqueous boric acid solution is generally 50° C. or more, and preferably from 50 to 85° C.

### Step (IV)

The PVA resin film after the treatment with boric acid is generally rinsed with water. The rinsing treatment with water may be performed, for example, by immersing the PVA resin film having been treated with boric acid in water. After rinsing with water, the film is dried to provide a polarizer. The temperature of water in the rinsing treatment with water is generally approximately from 5 to 40° C., and the immersing time is generally approximately from 2 to 120 seconds. The drying treatment performed thereafter is generally performed with a hot air drier or a far infrared heater. The drying temperature is generally from 40 to 100° C. The treating time for the drying treatment is generally approximately from 120 to 600 seconds.

According to the procedures, a polarizer containing a PVA resin film having iodine or a dichroic dye adsorbed and having been oriented is obtained.

### Step (V)

The adhesion of the polarizer and the optical film for protecting a polarizer may be performed with an adhesive layer. Examples of an adhesive constituting the adhesive layer include a PVA adhesive, an epoxy adhesive, an acrylic adhesive, a polyolefin grafted with an unsaturated carboxylic acid or an anhydride thereof, and a polyolefin adhesive containing the grafted polyolefin. Examples thereof also include a transparent adhesive, for example, a polyvinyl ether adhesive and a rubber adhesive. Among these, a PVA adhesive is preferred.

The PVA adhesive contains a PVA resin and a crosslinking agent, and examples of the PVA resin include PVA obtained through saponification of polyvinyl acetate and a derivative thereof, a saponified product of a copolymer of vinyl acetate and a copolymerizable monomer, and a modified PVA prepared through acetalization, urethanization, etherification, grafting, phosphatization or the like. The PVA resin may be used solely or in combination of two or more kinds thereof. Examples of the monomer copolymerizable with vinyl acetate include an unsaturated carboxylic acid and an ester thereof, such as maleic acid (or maleic anhydride), fumaric acid, crotonic acid, itaconic acid and (meth)acrylic acid; an α-olefin, such as ethylene and propylene; (meth)allylsulfonic acid (or a sodium salt thereof), sodium sulfonate (a monoalkylmaleate thereof), sodium disulfonate alkylmaleate, N-methylolacrylamide, an acrylamide alkylsulfonate alkali salt, N-vinylpyrrolidone and an N-vinylpyrrolidone derivative.

While the degree of polymerization and the like of the PVA resin are not particularly limited, the average degree of polymerization is generally approximately from 100 to 3,000, and preferably from 500 to 3,000, and the average degree of saponification is generally approximately from 85 to 100 mol %, and preferably approximately from 90 to 100 mol %, since good adhesiveness is obtained.

Examples of the epoxy adhesive include a hydrogenated epoxy resin, an alicyclic epoxy resin and an aliphatic epoxy resin. The epoxy resin may further contain a compound that promotes cationic polymerization, such as an oxetane compound and a polyol compound.

Particularly preferred examples of the acrylic adhesive include those containing, as a major component, a copolymer of an acrylate ester, such as butyl acrylate, ethyl acrylate, methyl acrylate and 2-ethylhexyl acrylate, and an α-monoolefin carboxylic acid, such as acrylic acid, maleic acid, itaconic acid, methacrylic acid and crotonic acid, (including those containing a vinyl monomer, such as acrylonitrile, vinyl acetate and styrene, added thereto) since they do not impair the polarizing characteristics of the polarizer.

A polyolefin having an unsaturated carboxylic acid or an anhydride thereof grafted therewith and a polyolefin having the grafted polyolefin mixed therewith may also be used as the adhesive. Examples of the polyolefin used in the graft reaction include low density polyethylene, high density polyethylene, polypropylene polymerized with a Ziegler catalyst or a metallocene catalyst, poly-1-butene, poly-4-methyl-1-pentene, an ethylene-propylene copolymer, an ethylene-1-butene copolymer, a propylene-1-butene copolymer and mixtures thereof. Examples of the unsaturated carboxylic acid and an anhydride thereof used in the graft reaction with the polyolefin include acrylic acid, methacrylic acid, maleic acid, maleic anhydride, citraconic acid, citraconic anhydride, itaconic acid and itaconic anhydride. The resulting modified polyolefin may be used as it is, or may be used after mixing with a polyolefin.

In the present invention, the polarizer and the adhesive layer may be imparted with an ultraviolet ray absorbability, for example, by treating with an ultraviolet ray absorbent, such as a salicylate ester compound, a benzophenol compound, a benzotriazole compound, a cyanoacrylate compound and a nickel complex compound.

The adhesive layer may be formed by applying the adhesive to either one surface or both surfaces of the optical film for protecting a polarizer or the polarizer. The thickness of the adhesive layer is preferably from 0.01 to 10 μm, and more preferably from 0.03 to 5 μm.

Upon adhering the optical film for protecting a polarizer and the polarizer, the surface of the optical film for protecting a polarizer that is in contact with the polarizer may be subjected to an adhesion facilitating treatment for the purpose of enhancing the adhesiveness. Examples of the adhesion facilitating treatment include a surface treatment, such as a corona treatment, a plasma treatment, a low pressure UV treatment and a saponification treatment, and a method of forming an anchor layer, which may be employed in combination. Among these, a corona treatment, a method of forming an anchor layer, and a method using these methods in combination are preferred.

The adhesive layer is then formed on the surface having been subjected to the adhesion facilitating treatment, and the polarizer and the optical film for protecting a polarizer are laminated to each other through the adhesive layer.

The polarizer and the optical film for protecting a polarizer may be adhered with a roll laminator or the like. The heating and drying temperature and the drying time may be appropriately determined depending on the kind of the adhesive.

### Others

The polarizer film having the optical film for protecting a polarizer of the present invention on one surface of the polarizer may have on the other surface the optical film for protecting a polarizer or a film formed of another resin. Examples of the film formed of another resin include a fumaric acid diester resin, a cellulose triacetate film a polyether sulfone film, a polyarylate film, a polyethyleneterephthalate film, a polynaphthalene terephthalate film, a polycarbonate film, a cyclic polyolefin film, a maleimide resin film and a fluorine resin film. The film formed of another resin may be a phase retardation film having a particular phase retardation.

The polarizer film is preferably a laminated product having at least one hardcoat layer for enhancing the surface property and the scratch resistance. Examples of the hardcoat layer include hardcoat layers containing a silicone resin, an acrylic resin, an acrylic silicone resin, an ultraviolet ray-curable resin and a urethane hardcoat agent, and among those, a hardcoat layer containing an ultraviolet ray-curable resin is preferred from the standpoint of transparency, scratch resistance and chemical resistance. One or more of the hardcoat layers may be used.

Examples of the ultraviolet ray-curable resin include at least one ultraviolet ray-curable resin selected from ultraviolet ray-curable acrylic urethane, ultraviolet ray-curable epoxy acrylate, ultraviolet ray-curable (poly) ester acrylate and ultraviolet ray-curable oxetane.

The thickness of the hardcoat layer is preferably from 0.1 to 100 μm, more preferably from 1 to 50 μm, and further preferably from 2 to 20 μm. A primer treatment may be performed under the hardcoat layer.

The polarizer film of the present invention may be subjected to a known antiglare treatment, such as antireflection and reflection reduction treatments.

### Image Display Device

The polarizer film of the present invention may be favorably used in various devices for displaying an image.

Examples of the image display device include a liquid crystal display device containing a liquid crystal cell, an organic electroluminescence (which is hereinafter referred to as “organic EL”) display device and a touch-sensitive panel, and the image display device is not limited in kind as far as it uses a polarizer film. In the case of a liquid crystal display, the image display device is generally produced by suitably assembling constitutive components including a liquid crystal cell, an optical film and optionally an illumination system and the like, to which a driving circuit is incorporated. In the present invention, the constitution of the image display device is not particularly limited provided that the aforementioned polarizer film is employed. Examples of the device include arbitrary image display devices, such as an image display device having the polarizer film on one surface or both surfaces of a liquid crystal cell, and one having a backlight or a reflection plate as an illumination system. The liquid crystal cell may be any of known ones including a TN type, an STN type and a it type. Upon constructing the image display device, for example, one layer or two or more layers of suitable components, such as a diffuser plate, an antiglare layer, an antireflection film, a protective plate, a prism array, a lens array sheet, a light diffusing plate and a backlight, may be disposed at suitable positions.

Liquid Crystal Display containing Liquid Crystal Cell

The polarizer film of the present invention may be favorably used by laminating, for example, an a liquid crystal cell.

As an example of the image display device of the present invention, a constitutional example of a liquid crystal display containing a liquid crystal cell is shown in FIG. 2. In FIG. 2, numeral 6 denotes a liquid crystal cell. Examples of the liquid crystal cell 6 include an active matrix driving cell, such as a thin film transistor type, and a simple matrix driving cell, such as a twisted nematic mode type and a super-twisted nematic type. On the liquid crystal cell 6, a phase retardation (birefringence) film 5 is laminated thereon through an adhesive layer (which is not shown in the figure) and the polarizer film 4 is further laminated thereon through an adhesive layer (which is not shown in the figure). The polarizer film 4 has a polarizer 2 at the center thereof and has optical films for protecting a polarizer 1 laminated on both surfaces thereof through adhesive layers 3. Upon laminating the polarizer film 4 and the phase retardation film and laminating the phase retardation film 5 and the liquid crystal cell 6, an adhesive layer may be provided in advance on the polarizer film 4, the phase retardation film 5 and the liquid crystal cell 6.

The adhesive for laminating the polarizer film and the liquid crystal cell is not particularly limited, and for example, an adhesive containing a base polymer appropriately selected from polymers, such as an acrylic polymer, a silicone polymer, polyester, polyurethane, polyamide, polyether, a fluorine polymer and a rubber polymer may be used. Among these, an acrylic adhesive is preferred since it is excellent in optical transparency, exhibits suitable adhesive characteristics including wettability, cohesiveness and adhesiveness, and is excellent in weather resistance and heat resistance.

The adhesive is demanded to be excellent in optical transparency, to have suitable adhesive characteristics including wettability, cohesiveness and adhesiveness, and to be excellent in weather resistance and heat resistance. Furthermore, such an adhesive layer is demanded that has low moisture absorbability and excellent heat resistance from the standpoint of preventing a foaming phenomenon and a peeling phenomenon caused by moisture absorption, preventing deterioration in optical characteristics of and warpage of the liquid crystal cell clue to differences in thermal expansion or the like, and securing formation of an image display device with high quality and excellent durability.

The adhesive may contain a natural or synthetic resin, particularly an adhesiveness-imparting resin, a filler containing glass fibers, glass beads, metal powder, other inorganic powder or the like, and an additive, such as a pigment, a colorant and an antioxidant. An adhesive layer exhibiting light diffusion property by containing fine particles may be used. The adhesive layer may be imparted with an ultraviolet ray absorption capability by a method of treating with an ultraviolet ray absorbent, such as a salicylate ester compound, a benzophenol compound, a benzotriazole compound, a cyanoacrylate compound and a nickel complex compound.

The coating method of the adhesive to the polarizer film is not particularly limited, and an appropriate method may be employed. Examples of the method include a method of dissolving or dispersing the base polymer or a composition thereof in a single material or a mixed material of a suitable solvent, such as toluene and ethyl acetate, to prepare an adhesive solution of approximately from 10 to 40% by mass, and applying the solution directly onto the polarizer film by a suitable spreading method, such as a casting method and a coating method, and a method of forming an adhesive layer on a releasable base film according to the aforementioned method and transferring the adhesive layer onto the polarizer film.

Examples of the coating method include various methods, such as gravure coating, bar coating, roll coating, reverse roll coating and comma coating, and gravure coating is most ordinarily employed.

The adhesive layer may have a multilayer structure of different compositions or kinds, which may be formed on one surface or both surfaces of the polarizer film. In the case where the layers are formed on both surfaces, the adhesives may not have the same composition and may not have the same thickness on both the front surface and the back of the polarizer film. Adhesive layers having different compositions or different thicknesses may be provided.

The thickness of the adhesive layer may be appropriately determined depending on the purpose, the adhesive power and the like, and is generally from 1 to 500 μm, preferably from 5 to 200 μm, and particularly preferably from 10 to 100 μm.

The exposed surface of the adhesive layer is preferably covered by temporarily attaching thereto a release film for the purpose of preventing the surface from being contaminated before use in practice. According to the procedure, the adhesive layer may be protected from contact in the ordinary handling conditions. The release film may be any known one, and example thereof include a thin sheet material, such as plastic film, a rubber sheet, paper, a woven fabric, a nonwoven fabric, a net, a foamed sheet, a metallic foil and laminated product thereof, which may be coated with a suitable releasing agent of a silicone series, a long-chain alkyl series, a fluorine series, a molybdenum sulfide series or the like depending on necessity.

### Organic EL Display Device

The polarizer film of the present invention may be favorably applied to an organic EL display device.

In general, an organic EL display device contains a light emitter (i.e., an organic electroluminescent emitter) formed by laminating a transparent electrode, an organic light emission layer and a metal electrode in this order on a transparent substrate. The organic light emission layer herein is a laminated product of various organic thin films, and structures with various combinations have been known therefor, examples of which include a laminated product of a hole injection layer containing a triphenylamine derivative or the like and a light emission layer containing a fluorescent organic solid, such as anthracene; a laminated product of the light emission layer and an electron injection layer containing a perylene derivative or the like; and a laminated product containing the hole injection layer, the light emission layer and the electron injection layer.

The organic EL display devices emits light according to such a principle that holes and electrons are injected into the organic light emission layer through voltage application to the transparent electrode and the metal electrode, thereby exciting the fluorescent substance with the energy generated through recombination of the holes and the electrons, and the excited fluorescent substance radiates light upon restoring to the ground state. The mechanism of recombination in the course of the process is the same as that in an ordinary diode, and as will be estimated from the process, the electric current and the light emission intensity exhibit strong nonlinearity accompanied with rectification relative to the applied voltage.

In the organic EL display device, at least one electrode is necessarily transparent for taking out light emitted by the organic light emission layer, and therefore, a transparent electrode formed of a transparent electroconductor, such as indium tin oxide (ITO), is generally used as an anode. For facilitating the electron injection to enhance the light emission efficiency, on the other hand, it is important to use a substance having a small work function as a cathode, and in general, a metal electrode, such as Mg—Ag and Al—Li, is used therefor.

In the organic EL display device having the aforementioned structure, the organic light emission layer is formed of an extremely thin film having a thickness of approximately 10 nm. Accordingly, the organic light emission layer completely transmits light therethrough as similar to the transparent electrode. As a result, in the absence of light emission from the device, light that is incident on the surface of the transparent substrate, and then reflected on the metal electrode after being transmitted through the transparent electrode and the organic light emission layer is again emitted toward the side of the surface of the transparent substrate, and therefore, the display surface of the organic EL display device seen from the outside looks like a mirror surface.

In the organic EL display device containing a transparent electrode on the front surface side of the organic light emission layer emitting light through voltage application and containing an organic electroluminescent light emitter equipped with a metal electrode on the back surface side of the organic light emission layer, a polarizer film may be provided on the front surface side of the transparent electrode, and a birefringence layer (phase retardation film) may be provided between the transparent electrode and the polarizer film.

The polarizer film has a function of polarizing light that is externally incident and reflected on a metal electrode, and therefore has a function of preventing the mirror surface of the metal electrode from being viewed from the outside, owing to the polarizing function thereof. In particular, in the case where the birefringence layer is constituted by a λ/4 plate and the angle between the polarizing directions of the polarizer film and the birefringence layer is controlled to π/4, the mirror surface of the metal electrode can be completely concealed.

Specifically, only the linearly polarized component of the light that is externally incident on the organic EL display device is transmitted owing to the polarizer film. The linearly polarized light generally becomes elliptically polarized light with the birefringence layer, but in the case where the birefringence layer is a λ/4 plate and the angle formed with the polarizing direction of the polarizer film is π/4, circularly polarized light is obtained. The circularly polarized light is transmitted through the transparent substrate, the transparent electrode and the organic thin film, then reflected on the metal electrode and again transmitted through the organic thin film, the transparent electrode and the transparent substrate, thereby again forming linearly polarized light at the birefringence layer. The linearly polarized light is perpendicular to the polarization direction of the polarizer film and thus is not transmitted through the polarizer film. As a result, the mirror surface of the metal electrode can be completely concealed.

### Touch-Sensitive Panel

The polarizer film of the present invention can be favorably applied to a touch-sensitive panel.

In general, a touch-sensitive panel is such a device that an operator touches a transparent surface provided on the top of a display panel with a pen or a finger to operate a device and a system. The direct touch on the panel surface is more direct and more intuitive as compared to an operation determining a position with a cursor by pushing direction keys, and has become often employed in recent years. Furthermore, owing to the remarkable growth of a mobile terminal market including a mobile phone and a PDA (personal digital assistant) in recent years, the devices are strongly demanded to be visible under sunlight and to be thin and lightweight. Various types of touch-sensitive panels are known and are differentiated for the use depending on the advantages and disadvantages thereof. Examples of the touch-sensitive panel include a resistance film type, an optical type, a capacitance coupling type (which may also be referred to as an analogue capacitive coupling type), an infrared ray type, an ultrasonic type and an electromagnetic conduction type. As an example, a resistance film type touch-sensitive panel will be described below.

A resistance-film type touch-sensitive panel includes a glass-glass type and a glass-film type. The glass-glass type contains a glass substrate having a transparent electroconductive layer and another glass substrate having a transparent electroconductive layer, which are held with a space between them, and the assembly is attached to the surface of the display. The glass-film type is for a vehicle-mounted or portable touch-sensitive panel and is demanded to have a lighter weight and a thinner profile, in which the upper glass substrate having a transparent electroconductive layer is replaced by an optical film.

A linear polarizer film or a circular polarizer film containing a combination of a polarizer film and a λ/4 plate laminated thereon may be used at the outermost surface of a touch-sensitive panel, whereby the touch-sensitive panel may have a sufficient strength, and the visibility is enhanced owing to the effect of antireflection. The optical film for protecting a polarizer of the present invention may be favorably used in the polarizer films in these touch-sensitive panels.

A circular polarizer film can be obtained by laminating a polarizer film containing the optical film for protecting a polarizer of the present invention and a polarizer, and a λ/4 plate in such a manner that the angle between the in-plane slow axis of the λ/4 plate and the polarization axis of the polarizer film is substantially 45°. The term substantially 45° means that the angle is from 40 to 50°. The angle between the in-plane slow axis of the λ/4 plate and the polarization axis of the polarizer film is preferably from 41 to 49°, more preferably from 42 to 48°, further preferably from 43 to 47°, and most preferably from 44 to 46°.

The optical film for protecting a polarizer of the present invention may be used as any of the upper or lower protective film or the lower outer protective film (the film for weight reduction provided with ITO) of the polarizer film. For antireflection of touch panels, a linear polarization type and a circular polarization type may be used (the linear polarization type has a higher refractive index than the circular polarization type), and the optical film for protecting a polarizer of the present invention may be used in any of the circular polarization type and linear polarization type polarizer films.

The circular polarizer film and the linear polarizer film containing the optical film for protecting a polarizer of the present invention may be used for any of transmission type and reflection type touch-sensitive panels.

### EXAMPLE

The present invention will be described in more detail with reference to examples, but the present invention is not limited to the examples.

### Optical Film for Protecting Polarizer

### Evaluation Method

### (1) Tensile Strength

The tensile strength was measured according to ASTM D63B (Type 4). The machine direction means the film flowing direction upon molding the mixed resin into a film form, and the transversal direction means the direction perpendicular to the machine direction in the film plane.

### (2) Haze Value

The haze value was measured according to JIS K7136.

### (3) In-Plane Phase Retardation

The in-plane phase retardation was measured with a phase retardation measuring apparatus (“KOBRA-21ADH”, produced by Oji Scientific Instruments Co., Ltd.) at a wavelength R of 589.5 nm and an incident angle of 0°.

### (4) Generation Status of Wrinkles

The generation status of wrinkles was evaluated by visually confirming the appearance of a wound roll of the molded film by the following standard.

A: no generation of wrinkles found (or generation of wrinkles found rarely)
B: slight generation of wrinkles found but with no practical problem
C: generation of wrinkles found

### (5) Generation Status of Film Breakage

The state of the film during the molding process in progress by the following standard.

A: no generation of accidental breakage of film found (or accidental breakage of the film found rarely)
B: slight generation of accidental breakage of film found but with no practical problem
C: considerable generation of accidental breakage of film found

### Example 1

Polypropylene polymerized with a metallocene catalyst (Wintec (trade name), produced by Japan Polypropylene Corporation, unmodified polymer, melting point: 135° C., bending elastic modulus: 1,200 MPa) and modified polypropylene obtained by graft-copolymerizing polymethyl methacrylate (PMMA) to random copolymerized polypropylene (produced by NOF Corporation, 50 parts by mass of PMMA per 100 parts by mass of modified polypropylene) were mixed at a ratio that provided a content of the PMMA component of 5% by mass in the mixed resin, and melted under heat. The mixed resin was molded by T-die single layer extrusion under conditions of a processing temperature of 200° C. and a take-up roll temperature of 30° C. to a film width of 1,000 mm and a film thickness of 100 μm, thereby providing an optical film for protecting a polarizer.

### Example 2

An optical film for protecting a polarizer was provided in the same manner as in Example 1 except that the polymers were mixed at a ratio that provided a content of the PMMA component of 15% by mass in the mixed resin.

### Example 3

An optical film for protecting a polarizer was provided in the same manner as in Example 1 except that the polymers were mixed at a ratio that provided a content of the PMMA component of 30% by mass in the mixed resin.

### Example 4

An optical film for protecting a polarizer was provided in the same manner as in Example 1 except that the polymers were mixed at a ratio that provided a content of the PMMA component of 3% by mass in the mixed resin.

### Example 5

An optical film for protecting a polarizer was provided in the same manner as in Example 1 except that the polymers were mixed at a ratio that provided a content of the PMMA component of 35% by mass in the mixed resin.

### Comparative Example 1

An optical film for protecting a polarizer was provided in the same manner as in Example 1 except that only the polypropylene polymerized with a metallocene catalyst (Wintec (trade name), produced by Japan Polypropylene Corporation, melting point: 135° C., bending elastic modulus: 1,200 MPa) was used, but the graft-modified polypropylene was not used.

### Comparative Example 2

An optical film for protecting a polarizer was provided in the same manner except that high density polyethylene (Novatec HB530 (trade name), produced by Japan Polypropylene Corporation, melting point: 136° C., bending elastic modulus: 1,600 MPa) was used instead of the modified polypropylene, and the polymers were mixed at a ratio that provided a content of the high density polyethylene component of 5% by mass in the mixed resin.

### Comparative Example 3

An optical film for protecting a polarizer was provided in the same manner as in Example 1 except that polypropylene polymerized with a Ziegler-Natta catalyst (Y2045GPP (trade name), produced by Prime Polymer Co., Ltd.) was used instead of the polypropylene polymerized with a metallocene catalyst in Example 1.

Table 1 shows the evaluation results of the optical films for protecting a polarizer obtained in Examples 1 to 5 and Comparative Examples 1 to 3. In Example 1 to 5, the tensile strength was enhanced by mixing the polypropylene polymerized with a metallocene catalyst and the PMMA graft-modified polypropylene, as compared to Comparative Example 1 where the PMMA graft-modified polypropylene was not mixed. In Comparative Example 1, in particular, there was a tendency that the edges of the film suffered breakage and wrinkles. In the case where the high density polyethylene was added in Comparative Example 2, the tensile strength was decreased, and wrinkles were formed throughout the film. In Comparative Example 3 where the polypropylene polymerized with a Ziegler catalyst was used, sufficient optical characteristics were not obtained.

In the case where the content of the PMMA component is 3% by mass in Example 4, breakage and wrinkles sometimes occurred at the edges of the film only slightly. In the case where the content of the PMMA component is 35% by mass in Example 5, the tensile strength in the transversal direction is decreased, and accidental breakage of the film occurred only slightly. Accordingly, it is understood that the content of the PMMA component in the mixed resin is preferably from 5 to 30% by mass. When the PMMA component is increased, the haze value and the phase retardation are gradually increased, and it is therefore understood that the PMMA component is preferably from 5 to 30% by mass from the standpoint of suppressing the influence thereof.

In the case where the tensile strength in the machine direction was 30 MPa or more in Examples 1 to 3 and 5, wrinkles were not formed (or were formed only slightly), thereby providing a good wound state. In the case where both the tensile strengths in the machine direction and the transversal direction were 30 MPa or more in Examples 1 and 2, accidental breakage of the film did not occur, thereby performing the molding stably.

TABLE 1

| | Mass | | | | | | |
|---|---|---|---|---|---|---|---|
| | proportion of | Tensile strength | | | In-plane | | Evaluation |
| | PMMA | Machine | Transversal | Haze | phase | | of film |
| | component | direction | direction | value | retardation | Evaluation of | breakage |
| | (% by mass) | (MPa) | (MPa) | (%) | (nm) | wrinkle state | state |
| Example 1 | 5 | 35.5 | 36.4 | 5 | 5 | A | A |
| Example 2 | 15 | 32.2 | 39.9 | 7 | 7 | A | A |
| Example 3 | 30 | 36.6 | 26.1 | 10 | 9 | A | B |
| Example 4 | 3 | 29.0 | 28.5 | 3 | 5 | B (edge part) | A |
| Example 5 | 35 | 42.7 | 14.9 | 18 | 12.5 | A | B |
| Comparative | — | 24.0 | 22.6 | 1 | 5 | C (edge part) | A |
| Example 1 | | | | | | | |
| Comparative | —*¹ | 20.0 | 20.1 | 30 | 100 | A | C |
| Example 2 | | | | | | | |
| Comparative | 5 | — | — | 20 | 20 | — | — |
| Example 3 | | | | | | | |

*¹mass proportion of high density polyethylene component in mixed resin: 5% by mass

### Polarizer Film

### Evaluation Method

### (6) Heat Resistance Test

A specimen was allowed to stand in an oven at a temperature of 90° C. with humidity not controlled for 1,000 hours, and then the sample was visually evaluated for presence of deformation and coloration. The evaluation standard is as follows.

A: no deformation and coloration found
C: deformation and/or coloration found

### (7) Humidity and Heat Resistance Test

A specimen was allowed to stand in an oven at a temperature of 90° C. and a humidity of 95% RH for 1,000 hours, and then the sample was visually evaluated for presence of deformation and coloration. The evaluation standard is as follows.

A: no deformation and coloration found
C: deformation and/or coloration found

### Example 6

The optical films for protecting a polarizer obtained in Example 2 (width: 150 mm, length: 150 mm) were adhered to both surfaces of a polyvinyl alcohol film having iodine adsorbed and oriented thereon, through PVA obtained by saponifying polyvinyl chloride, thereby providing a polarizer film.

### Comparative Example 4

Cellulose triacetate films (Fujitac (trade name), produced by Fujifilm Corporation) (width: 150 mm, length: 150 mm) were adhered to both surfaces of a polyvinyl alcohol film having iodine adsorbed and oriented thereon, through PVA obtained by saponifying polyvinyl chloride, thereby providing a polarizer film.

Table 2 shows the evaluation results of the polarizer films obtained in Example 6 and Comparative Example 4. The polarizer film of Example 6 suffered no deformation or yellowing in the heat resistance test and the humidity and heat resistance test. On the other hand, the polarizer film of Comparative Example 3 suffered yellowing in the heat resistance test and suffered separation of adhesion at the portion from the edge by approximately 2 mm due to deformation in the humidity and heat resistance test.

TABLE 2

| | | Humidity and heat |
|---|---|---|
| | Heat resistance test | resistance test |
| Example 6 | A | A |
| Comparative Example 4 | C (yellowing) | C (yellowing) |

### INDUSTRIAL APPLICABILITY

The optical film for protecting a polarizer of the present invention is excellent in mass productivity and is capable being imparted with characteristics by application while maintaining optical characteristics and moisture resistance of polypropylene polymerized with a metallocene catalyst, and thus is favorably applied to production of a polarizer film by combining a polarizer. The polarizer film thus obtained is effectively utilized in an image display device, such as a liquid crystal display device containing a liquid crystal cell, an organic electroluminescence (which is hereinafter referred to as “organic EL”) display device and a touch-sensitive panel.

1. An optical film for protecting a polarizer, comprising a mixed resin containing polypropylene that is polymerized with a metallocene catalyst, and graft-modified polypropylene.

2. The optical film for protecting a polarizer according to claim 1, wherein the graft-modified polypropylene is modified polypropylene graft-copolymerized with an acrylic compound.

3. The optical film for protecting a polarizer according to claim 1, wherein the graft-modified polypropylene is modified polypropylene graft-copolymerized with a vinyl compound.

4. The optical film for protecting a polarizer according to claim 1, wherein the graft-modified polypropylene is modified polypropylene graft-copolymerized with styrene or a derivative thereof.

5. The optical film for protecting a polarizer according to claim 2, wherein the acrylic compound is acrylic acid, methacrylic acid, or a derivative thereof.

6. The optical film for protecting a polarizer according to claim 5, wherein a mass proportion of a constitutional component derived from acrylic acid, methacrylic acid, or a derivative thereof in the mixed resin is from 5 to 30% by mass.

7. The optical film for protecting a polarizer according to claim 5, wherein the optical film for protecting a polarizer has tensile strengths in a machine direction and a transversal direction each of 30 MPa or more.

8. A polarizer film comprising a polarizer having on at least one surface thereof the optical film for protecting a polarizer according to claim 1.

9. An image display device comprising the polarizer film according to claim 8.

10. A method for producing an optical film for protecting a polarizer, comprising the following steps (1) to (4):
step (1): a step of synthesizing polypropylene with a metallocene catalyst;
step (2): a step of graft-copolymerizing a branch polymer to polypropylene as a stem polymer, thereby synthesizing graft-modified polypropylene;
step (3): a step of mixing and melting under heat the polypropylene polymerized with a metallocene catalyst and the graft-modified polypropylene, thereby providing a mixed resin; and
step (4): a step of molding the mixed resin.
